(19) United States
(12) Patent Application Publication
(10) Pub. No.: US 2002/0019471 A1
(43) Pub. Date: Feb. 14, 2002

(54) Injection moldable polyamide resin compositions and articles made therefrom

(76) Inventor: Masahiro Nozaki, Utsunomiya-shi (JP)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/858,797

(22) Filed: May 16, 2001

Related U.S. Application Data
(60) Provisional application No. 60/204,804, filed on May 17, 2000.

(51) Int. Cl. C08K 5/24; C08L 91/06

(52) U.S. Cl. 524/261; 524/275

(57) ABSTRACT

Polyamide resin compositions are provided that are injection-moldable, and comprising nylon 6 or nylon 6,6 having a RV of from 70-470 (in 90% formic acid) or nylon 6,12 having a RV of from 2.40-4.50 (in 98% sulfuric acid). The compositions may also include polytetrafluoroethylene powder or high viscous silicone, and other fillers and additives. These compositions exhibit improved properties, and are particularly suited for gear assemblies.

### BACKGROUND OF THE INVENTION

1. Field of the Invention

This invention relates to polyamide resin compositions suitable for the injection molding of articles having high durability. More particularly, this invention relates to such compositions in which the polyamide resin is of a desirable molecular weight and optionally including a variety of additives (including silicone and lubricants), so that articles made therefrom exhibit improved fatigue resistance and low friction properties.

2. Description of Related Art

Polyamide resin compositions are widely recognized as the materials of choice for any number of molding applications. Significant attention has been directed towards the development of nylons that are stiff, tough, and heat stable. These properties are desirable from the standpoint of manufacturing articles that can exhibit characteristics required in today's demanding and rigorous end-use applications.

Japanese laid-open application 62-185747 is directed to compositions of polyamide 4,6 (and having a relative viscosity (RV) of greater than 1.5 and preferably 2.5-5.0) in combination with polytetrafluoroethylene powder (less than 15 microns in size), and optionally fillers (0-60 wt %). However, this reference mentions only improved friction performance with 4,6 nylon and does not mention the rationale for selection of the viscosity range (nor the preferred range) nor does it relate properties to the viscosity range.

Japanese laid open patent 9-89081 discloses an injection molding gear for use in general purpose engines, which is formed by injection molding a polyamide resin such as polyamide 66 followed by heat treatment, with a relative viscosity measured in a 1.0% concentration solution of 98% sulfuric acid of greater than 3.5. However, it does not recognize or suggest the problem of adverse effects on a variety of mechanical properties. In particular dimensional accuracy (due to the necessity of heat treatment after molding) can be affected, resulting in a loss of balance of mechanical properties of polyamide moulded gears.

Japanese laid-open application 10-60269 is representative of nylon compositions intended for the manufacture of molded parts. There is disclosed therein high molecular weight polyamides having an intrinsic viscosity greater than 3.0 and in combination with polyolefins. However, its teachings are limited to compression molding applications.

Monomer cast nylon 6 is commonly used for gears. However, this is not injection-moldable, limiting its usefulness in a variety of demanding applications. The monomer cast nylon is available mainly in stock shapes out of which finished products are machined; see the Nylon Plastics Handbook from HANSER, P.542. This requires two production steps for making gears; namely, cutting of the stock to be a suitable size for the gears and then machining of gear teeth.

It is an object of the present invention to provide a polyamide resin composition which is injection moldable, and further which is used to produce articles having improved durability. It is a further object of the invention to provide injection moldable articles that exhibit remarkable fatigue and low friction, with its balance of such properties. One feature of the invention is its suitability for the manufacture of gears (such as automotive steering assist gears, window lifting gears and wiper motor gears) which are capable of withstanding high loads placed on the gear teeth. This promotes an improvement in the life of such gears. It is an advantage of the present invention that the polyamide resins disclosed herein may include a number of additives which increase fracture toughness, lubricity, and the like. These and other objects, features and advantages of the present invention will become more readily apparent upon having reference to the following description of the invention.

### SUMMARY OF THE INVENTION

This invention provides an injection moldable polyamide resin composition comprising nylon 6 or nylon 6,6 having a relative viscosity (RV) from 70 to 470 in 90% formic acid, or nylon 6,12 having a relative viscosity (RV) from about 2.40 to 4.50 in 98% sulfuric acid.

Compositions of the invention may also comprise silicone, in a range of 1-10 weight percent. Other additives, such as waxy lubricants, aliphatic and/or aromatic acid esters, ether and amides, may also be incorporated into the compositions of the invention, in amounts of 0.05-5 weight percent. Silicone and waxes in particular have been found to desirably enhance fracture toughness for a specified molecular weight range. Any of the above compositions may also further include olefin elastomers and inorganic or organic fillers, in amounts ranging from 2 to 30 weight percent.

The present compositions are versatile, and may be blended with any of a variety of polyamide resins having a Tg of at least 80 C., and in amounts of from 5-85 weight percent.

### DETAILED DESCRIPTION OF THE INVENTION

The polyamides useful in the present invention comprise nylon 6, nylon 6,6 and nylon 6,12. These designations are readily understood by those skilled in the art. For example, representative nylons may be selected from saturated linear nylon homopolymers, such as polycaprolactam (nylon 6) polyhexamethlyene dodeconedicarboxylic acid (nylon 6, 12) and polyhexemethylene adipamide (nylon 6,6). Useful nylon homopolymers may be produced using adipic acid, azelaic acid, sebacic acid, dodecanedicarboxylic acid, isophtharic acid or terephthalic acid, and in conjunction with hexamethylenediamine, 2-methyl-pentamethylenediamine, octamethylendiamine, nonamethylendiamine, 2-methyl-octamethylenediamine, trimethylhexamethylenediamine, bis-(4-aminocyclohexyl)-methane or 2,2-bis(4′-aminocyclohexyl)-propane. Polyamides with a Tg of at least 80 C. typically contain at least 20 mol % of aromatic monomer. These may be manufactured using a variety of techniques also readily known and appreciated among those skilled in the art. For example polymerization in an autoclave one step or continuous polymerization by applying suitable pressure and temperature is taught in U.S. Pat. No. 5,378,800 incorporated by reference herein. An alternative process includes preparing a prepolymer and subjecting the prepolymer to solid-phase polymerization or melt-mixing in an extruder to increase the degree of polymerization. Further, the above polymerized polymer is further polymerized by solid-phase polymerization in order to increase molecular weight.

The nylons described above and in the RV ranges set forth herein may also be blended with other materials having a high glass transition temperature. The selection of the appropriate blend is a function of the end use of the polymeric material.

The aforementioned polyamides are preferable for a number of applications requiring high durability, such as gears in which the gear teeth are under exceptional loads. One such area of interest is automotive steering assist gears, which are subject to loading environments that often cause gear teeth to chip or fracture. Specifically, these polyamides in the RV ranges specified impart injection-moldability to the compositions, thereby significantly improving fracture toughness as compared to standard grades of polyamides. This higher fracture toughness is a critical factor for longer gear life and provides high fatigue resistance.

It should be noted that while some gears contemplated herein are preferentially made through the injection molding process and include gear teeth formed thereon, other gears of interest are first injection molded and next undergo machining operations to form the gear teeth. Both concepts are considered within the purview of the invention disclosed herein.

There are two factors essential to the promotion of long gear life—fatigue resistance and low friction. The polyamides identified as above are well suited for parts which must exhibit these properties. The high molecular weight of the polymer is found to provide high fracture toughness, which in turn promotes high fatigue resistance. This property is very important for longer gear life because the gear teeth must resist repeated impact from other gears and gear teeth during power transmission. Broken gears are often associated with fatigue.

Low friction—the other factor—provides less heating of the gear teeth by friction between gears. Polymer when heated up exhibits a lower strength and modulus (e.g. it is easy to deform).

Another benefit associated with the compositions of the invention is that the compositions do not require heat treatment after injection molding, and the dimensional stability is observed.

Any of a number of additives may be incorporated with the polyamides disclosed herein to enhance low friction properties between the gears. These include without limitation polytetrafluoroethylene (PTFE) and silicone, and preferably silicone. Further, waxy lubricants such as aliphatic and/or aromatic esters, ethers and amides, desirably enhance fracture toughness for a specified molecular weight range.

In addition, fillers of inorganic or organic have been identified as improving creep resistance; these include inorganic fillers such as wollastenite, kaolin, talc, mica, almina, silica, magnesium oxide, calcium silicate, magnesium silicate, metal whisker, potassium titanate whisker and the like organic fillers such as carbon fiber, aramid fiber (for example KEVLAR® brand fiber available from EI DuPont de Nemours and Company), etc. These fillers are added during compounding or injection molding process with the polyamide.

A number of olefin elastomers have been identified as useful to incorporate into the polyamide compositions of the invention. For example, an elastomer of ethylene- -olefin, ethylene-propylene-diene, ethylene-unsaturated carboxylic acid, ethylene-unsaturated carboxylic acid ester, ethylene-unsaturated carboxylic acid-unsaturated carboxylic acid ester, -olefin-unsaturated carboxylic acid, -olefin unsaturated carboxylic acid ester, -olefin-unsaturated carboxylic acid-unsaturated carboxylic acid ester, ethylene- -olefin-unsaturated carboxylic acid-unsaturated carboxylic acid ester; and modified materials of the above-mentioned elastomers in order to graft to polyamides. The modification is done by addition of organic acids such as maleic anhydride, fumaric anhydride, or etc.

The invention will be better understood upon having reference to the following examples of the invention.

### EXAMPLES

Test Method

Testing for energy for breakage was conducted using molded specimens having the following dimensions: 12 mm high×125 mm in length×3.2 mm in thickness. The mold specimen has a notch with identical in both shape and size to that set forth in the ASTM D256 test at the center of test specimen. The testing proceeded in the manner that the specimen was bent from the opposite side of the notch. The test speed of bending was 10 mm/minute and the span for the bending test was 50 mm. Energy for breakage was calculated in the following manner: calculate area of stress-strain curvature up to break and then divide by initial volume in-between the span. Higher fracture toughness was estimated by higher energy for breakage.

Testing for friction coefficient was conducted using tensile bars based on ASTM D638, and measured at 1 Hz, 32.5 mm ampritude under 2.0 kgf load.

Molding conditions for nylon 6,6 and nylon 6,12 included a mold temperature of 65 C. and a melt temperature of 300 C.

RV is expressed in relation to formic acid or sufuric acid. For example, for nylon 6,6 the RV range in 90% formic acid was determined by dissolving a 2.2 g of polyamide in 20 ml of 90% formic acid. For nylon 6,12 the RV range in 98% sulfuric acid was determined by dissolving a 0.25 g of polyamide in 25 ml of 98% sulfuric acid.

Test Compositions and Their Properties

The details and findings of the experimental work can be found in the following table.

### Example 1-3 and Comparative Example 1

Nylon 66 compositions containing about 0.4% of inorganic heat stabilizer (HS) and with various relative viscosities (RV) were prepared as in table 1. Energy for breakage and friction coefficient were measured.

### Example 4-5 and Comparative Example 2

Nylon 612 composition with various relative viscosities (RV) were prepared as in table 2. Energy for breakage and friction coefficient were measured.

### Example 6-8 and Comparative Example 3

Nylon 66 compositions containing about 0.4% of inorganic heat stabilizer (HS) and with various RV were prepared as in table 3. Example 6-7 contains BY27-005 (nylon 66:Silicone gam 50:50) and Example 8 contains waxy lubricant, ethylene glycol di-stearate. Energy for breakage and friction coefficient were measured.

### Example 9-12 and Comparative Example 4

Nylon 66 compositions containing about 0.4% of inorganic heat stabilizer (HS) and with various RV was prepared around 70 as on the table 4. Example 9-12 contain various type of waxy lubricants, such as N-Stearyl ercamide and poly ethylene glycol 2-ethyl hexoate. Energy for breakage and friction coefficient were measured.

Overall, it was found that certain ranges of RV values provided higher energy for breakage, which expects to improve fatigue and creep resistance (ex. 1-5). The addition of silicone and wax into the subjective RV nylon 66 also provided higher energy for break than that of the subjective RV (ex. 6-12).

TABLE 1

| | Example 1 | Example 2 | Example 3 | Compara. 1 |
|---|---|---|---|---|
| Nylon66 + HS | 100.00 | 100.00 | 100.00 | 100.00 |
| RV | 73 | 162 | 250 | 48 |
| Energy for | 2.4 | 6.6 | 12.0 | 1.6 |
| breakage | | | | |
| kg.cm/cm3 | | | | |
| Friction | | | 0.29 | 0.27 |
| coefficient | | | | |

TABLE 2

| | Example 4 | Example 5 | Compara. 2 |
|---|---|---|---|
| Nylon 612 | 100.00 | 100.00 | 100.00 |
| RV | 2.72 | 3.12 | 2.28 |
| Energy for breakage kg.cm/cm3 | 4.8 | 9.1 | 1.9 |
| Friction coefficient | | 0.30 | 0.30 |

TABLE 3

| | Example 6 | Example 7 | Example 8 | Compara. 3 |
|---|---|---|---|---|
| Nylon66 + HS | 95.00 | 90.00 | 99.00 | 100.00 |
| BY27-005 | 5.00 | 10.00 | | |
| (Nylon66/Silicone | | | | |
| gam 50/50) | | | | |
| Ethyelene glycol | | | 1.00 | |
| di-srearate | | | | |
| RV | 117 | 106 | 104 | 101 |
| Energy for | 3.7 | 4.5 | 3.3 | 2.5 |
| breakage kg.cm/cm3 | | | | |
| Friction coefficient | 0.22 | 0.20 | 0.28 | |

TABLE 4

| | Example 1 | Example 2 | Example 3 | Compara. 1 |
|---|---|---|---|---|
| Nylon66 + HS | 100.00 | 100.00 | 100.00 | 100.00 |
| Rv | 73 | 162 | 250 | 48 |
| Energy for | 2.4 | 6.6 | 12.0 | 1.6 |
| breakage kg.cm/cm3 | | | | |
| Friction coefficient | | | 0.29 | 0.27 |

What is claimed is:

1. An injection moldable polyamide resin composition comprising nylon 6 or nylon 6,6 having a relative viscosity (RV) from 70 to 470 in 90% formic acid, or nylon 6,12 having a relative viscosity (RV) from 2.40 to 4.50 in 98% sulfuric acid.

2. The composition of claim 1 further comprising silicone, in an amount of 1-10 weight percent.

3. The composition of claim 1 further comprising an additive selected from the group consisting of waxy lubricant, aliphatic and/or aromatic ester, ether and amides, in an amount of 0.05-5 weight percent.

4. A gear manufactured from any of the compositions of claims 1, 2 or 3.

5. A method for the manufacture of a gear from the compositions of claims 1, 2 or 3 by first injection molding said gear and next machining said gear to form the gear teeth.
